(19) United States
(12) Patent Application Publication
(10) Pub. No.: US 2012/0055031 A1
(43) Pub. Date: Mar. 8, 2012

(54) CUTTING EDGE FOR A CUTTING TOOL

(75) Inventors: Mark B. Latronico, Charlotte, NC (US); Joseph Lutgen, Lake Forest, CA (US)

(73) Assignee: IRWIN INDUSTRIAL TOOL COMPANY, Huntersville, NC (US)

(21) Appl. No.: 12/875,511

(22) Filed: Sep. 3, 2010

(51) Int. Cl. B26B 17/00; B21K 5/12; B23P 15/28

(52) U.S. Cl. 30/191; 30/175; 76/119

(57) ABSTRACT

A cutting tool comprises a first cutting edge and a second cutting edge where the cutting edges are movable into engagement with one another. At least one of the cutting edges comprises an edge tip extending along at least a portion of the cutting edge. The edge tip has a curved outer surface that in cross-section is bounded by a first line defined by the equation y=74x² where x is within the range −0.023 inches≦x≦0.023 inches and a second line defined by the equation y=294x² where x is within the range −0.012 inches≦x≦0.012 inches. The outer surface may also be within a range defined by predetermined coordinates.

The invention relates generally to cutting tools such as cutting pliers and more particularly to an improved cutting edge for such tools.

### BACKGROUND

Cutting tools such as cutting pliers are known to be used to cut articles such as wire. The typical cutting tool comprises a first jaw connected to a second jaw at a pivot such that the jaws may be moved toward and away from one another. The jaws include cutting edges that are disposed opposite to one another such that the cutting edges engage one another when the jaws are closed. A handle may be connected to each jaw where the handles act as levers to close the jaws when the handles are squeezed by an end user. An article may be located between the jaws and the jaws closed such that the cutting edges engage and sever the article.

### SUMMARY OF THE INVENTION

A cutting tool comprises a first cutting edge and a second cutting edge where the cutting edges are movable into engagement with one another. At least one of the cutting edges comprises an edge tip extending along at least a portion of the cutting edge. The edge tip, in cross-section, has a curved outer surface that is within a range bounded by a first line defined by the equation y=74x² where x is within the range −0.023 inches≦x≦0.023 inches and a second line defined by the equation y=294x² where x is within the range −0.012 inches≦x≦0.012 inches.

The edge tip defines a plane that extends through the first cutting edge and the second cutting edge and the edge tip may be symmetrical about the plane. The first cutting edge may be formed on a first jaw and the first jaw may be operatively connected to a first lever arm and the second cutting edge may be formed on the second jaw and the second jaw may be operatively connected to a second lever arm. The second cutting edge may have a second curved surface that is the same as the curved surface of the first cutting edge. The second cutting edge may also comprise a second edge tip extending along at least a portion of the second cutting edge where the second edge tip has a curved surface that is also within the range bounded by lines defined by the equation y=74x² where x is within the range −0.023 inches≦x≦0.023 inches and the equation y=294x² where x is within the range −0.012 inches≦x≦0.012 inches. The first jaw and second jaw may also comprise gripping surfaces. The first cutting edge may extend for the length of the first jaw and the second cutting edge may extend for the length of the second jaw. The geometry of the outer surface may extend for 0.040 inches from the distal end of the edge tip.

### BRIEF DESCRIPTION OF THE DRAWINGS

FIG. 1 is a side view of an embodiment of a diagonal pliers and cutting edge of the invention.

FIG. 2 is a section view of a first embodiment of the cutting edge taken along line 2-2 of FIG. 1.

FIG. 3 is a section view similar to that of FIG. 2 of a second embodiment having two cutting edges.

FIG. 4 is a detailed view of the cutting edge of the invention.

FIG. 5 is a partial perspective view showing a jaw with a cutting edge of the invention.

FIG. 6 is a side view of an embodiment of a long-nose pliers and cutting edge of the invention.

FIG. 7 is a side view of an embodiment of a linesman pliers and cutting edge of the invention.

FIG. 8 is a side view of an embodiment of an end cutter and cutting edge of the invention.

FIG. 9 is a side view of an embodiment of a diagonal pliers and cutting edge of the invention.

FIG. 10 is a block diagram illustrating a method of making a cutting tool.

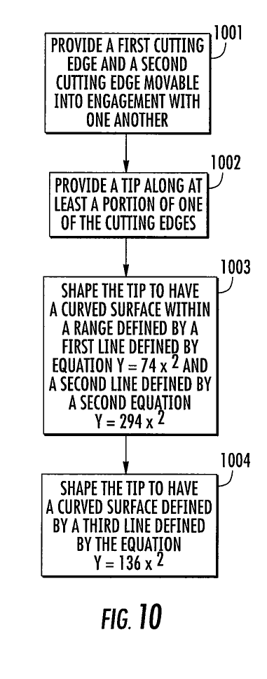

### DETAILED DESCRIPTION OF EMBODIMENTS OF THE INVENTION

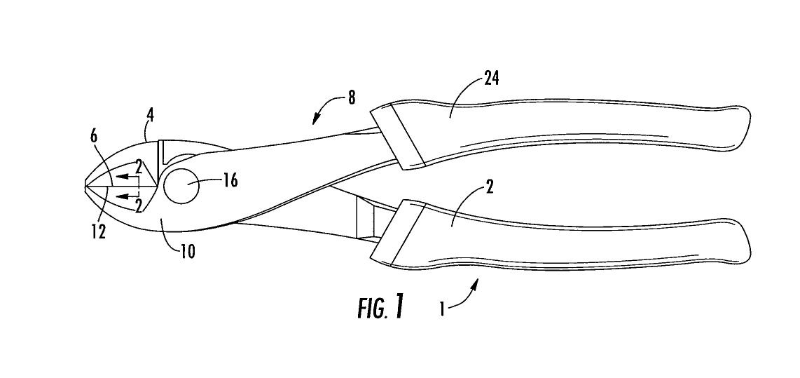

FIG. 1 shows an embodiment of a cutting tool implementing the cutting edge. While specific embodiments of edge-to-edge cutting pliers are shown, the cutting edge has applicability to any tool where the force generation characteristics and cutting edge durability of the cutting edge of the invention may be useful including powered cutting systems. The term “edge-to-edge” is used herein to refer to a cutting tool that operates by having the two cutting edges meet in abutting relationship when jaws are in the closed position. The cutting edge of the invention may also be used on edges that are offset or that move past one another during the cutting stroke.

Referring to FIG. 1 a first embodiment of a diagonal cutting tool is shown comprising a first lever assembly 1 that comprises a first handle 2 fixed to a first jaw 4. The first jaw 4 is formed with a first cutting edge 6. A second lever assembly 8 comprises a second handle 24 that is fixed to a second jaw 10. In one embodiment, the handles and jaws may be made integrally with one another and may have a one-piece construction. The second lever assembly 8 is pivoted to the first lever assembly 1 at pivot 16. The second jaw 10 comprises a second cutting edge 12. The second cutting edge 12 is disposed opposite to the first cutting edge 6 such that when jaws 4 and 10 are closed the cutting edges 6, 12 are in edge-to-edge contact with one another. The first jaw 4 can rotate toward and away from the second jaw 10 by manipulating handles 2 and 24 such that an article may be located between the cutting edges 6 and 12 and cut.

The invention relates to a cutting edge geometry for use in such cutting tools. The cutting force required to cut soft materials, such as electrical cable, is lowered by the geometry of the cutting edge. Cutting edges on such cutting tools may be damaged through use and abuse. The damage is often the result of cutting hard materials such as cable, wire, bolts or screws and may deform the cutting edges. The cutting edge geometry of the invention comprises an edge tip that lowers the cutting force required to cut through materials while providing an edge that is resistant to damage.

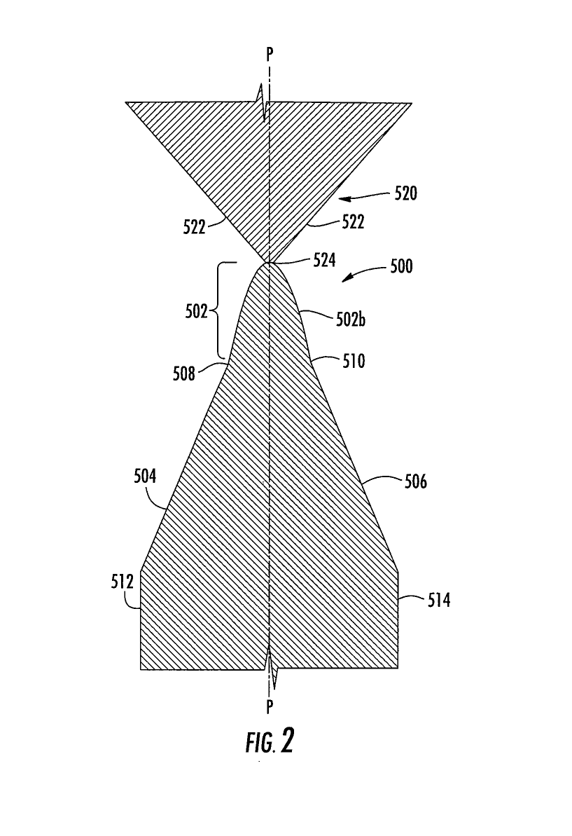

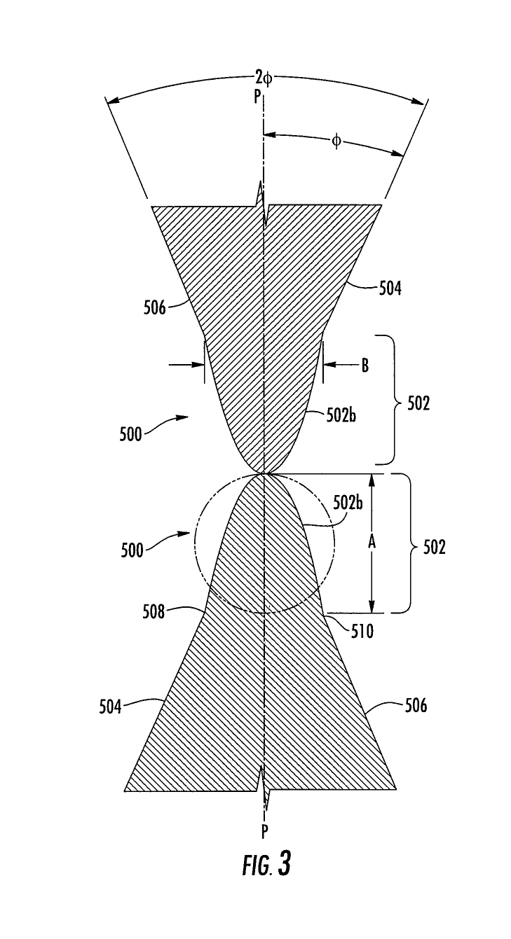

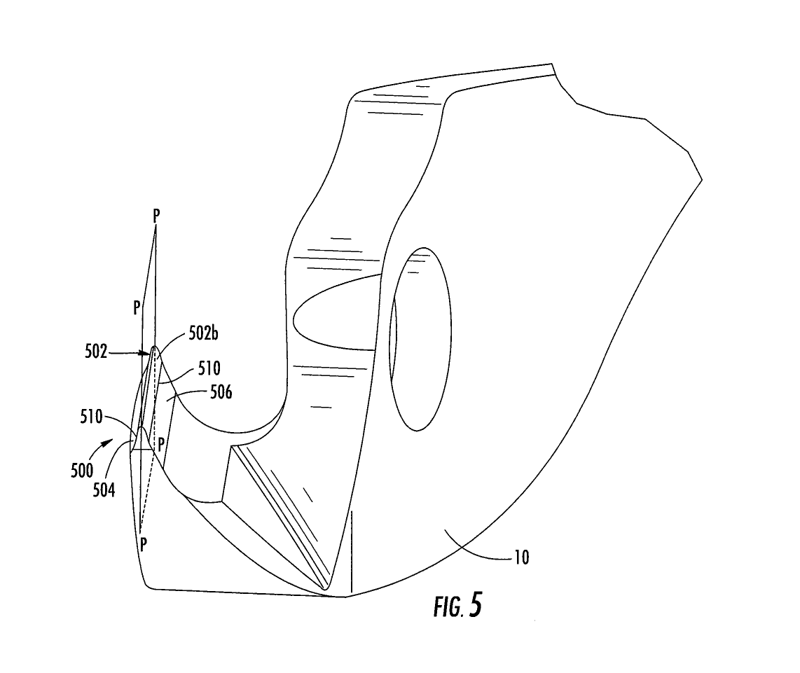

The shape of edge tip 502 will be described with Reference to FIGS. 2, 3, 4 and 5. Referring to FIG. 5, the shape of the edge tip 502 will be described with reference to the plane p-p where plane p-p extends along the length of the cutting edge 500 and is centered on the edge tips 502 and defines the plane of the two cutting edge tips when the cutting edge tips make edge-to-edge contact as shown in FIGS. 2 and 3. When a cross-section of the edge tip 502 is taken perpendicular to plane p-p, the plane p-p represents the central axis p-p of the cross-section of the edge tip as shown in FIGS. 2, 3 and 4. The outer surface 502b of the edge tip 502 extends in three dimensions for the length of the cutting edge as shown in FIG. 5 such that at any cross-section of the cutting edge tip, the shape of the outer surface of the cutting edge tip has a geometry as shown in, and described with respect to, FIGS. 2, 3 and 4. The edge tip 502 is preferably symmetrical about plane p-p. The cutting edge 500 with edge tip 502 may be used as the cutting edges in any of the illustrated cutting tools or in any similar cutting tool.

Referring to FIGS. 2 and 3 an embodiment of the cutting edge 500 is shown. Cutting edge 500 has a rounded edge tip 502 that transitions to angled back relief surfaces 504, 506 at corner breaks 508, 510. The width B of the edge tip 502 at its base is preferably between approximately 0.033 inches and 0.045 inches. The edge tip 502 has a height A of approximately 0.040 inches and the back relief surfaces 504, 506 extend at an angle φ of approximately 15° to 40° with a preferred angle of about 23° relative to the axis p-p. The angle φ of the flat relief surfaces 504, 506 may vary and the angle of the relief surfaces is used primarily to force the severed ends of the article being cut apart from one another. The back relief surfaces 504 and 506 may transition to parallel flat faces 512, 514 although surfaces 512 and 514 may be other than flat and parallel. The embodiment of FIG. 2 shows the edge tip 500 of the invention used on only one of the opposed cutting edges of a cutting tool while the embodiment of FIG. 3 shows the edge tip 500 of the invention used on both of the opposed cutting edges of a cutting tool. The opposed cutting edge 520 in the embodiment of FIG. 2 may have any suitable profile such as the illustrated angled flat relief faces 522 joined by a flat anvil face 524 where the edge tip 500 of the invention contacts the flat face 524.

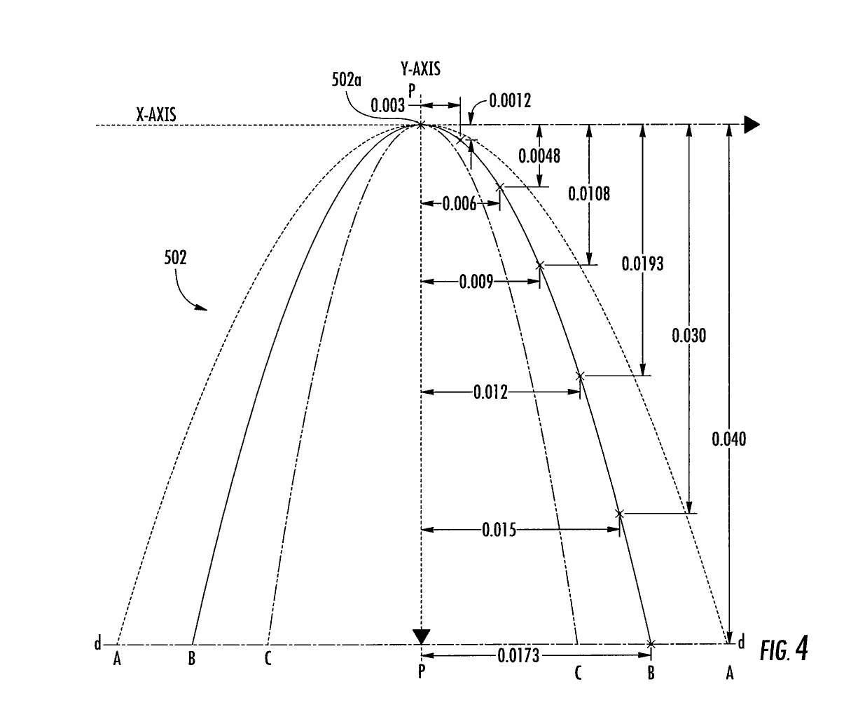

The edge tip 502 has a curved outer surface 502b that may extend for the length of the cutting edge 500. The outer surface 502b comprises a rounded distal end 502a that is the apex of the curve that forms the outer surface 502b. The distal end 502a forms the leading edge of the edge tip 502 and is the line of contact between the two jaws. In cross-section the outer surface of the edge tip 502 has a curved shape that is parabolic or approximately parabolic. To describe the shape of the edge tip 502 reference is made to FIG. 4 where the axis p-p is defined as the y-axis which is intersected by a perpendicular x-axis where coordinates 0, 0 are located at the distal end 502a of edge tip 502.

The outer surface 502b of the edge tip 502, in cross-section, lies within the range bounded by Line A-A defined by the equation y=74x² where x is within the range (−0.023 inches≦x≦0.023 inches) and Line C-C defined by the equation y=294x² where x is within the range (−0.012 inches≦x≦0.012 inches). The outer surface 502b of the edge tip 502 may be within this range where the outer surface has a curved shape that approximates the shapes of lines A-A and C-C. The outer surface of the edge tip 502 falls within the area bounded by the line A-A and the line C-C along the length of the edge tip. A preferred outer surface 502b of the edge tip 502, in cross-section, lies on the line B-B defined by the equation y=136x² where x is within the range (−0.017 inches≦x≦0.017 inches) Because the tip 502 has a height A of approximately 0.040 inches the scale of the tip is relatively small such that there will be some variation in the curve that defines the tip due to manufacturing tolerances. Thus, an edge tip that has a curved surface that has a cross-sectional shape approximating the parabolic shape of the described curves and that has a cross-sectional area similar to the cross-sectional area of the described edge tip will provide the desired performance. It has been found that a curved outer surface having a shape similar to that described that has cross-sectional area beneath surface 502b from distal end 502a to a transverse line d-d that is 0.040 inches from distal end 502a that is approximately 0.001 square inches provides the improved cutting performance and durability of the invention.

The equations set forth above define a smooth curve. The benefits of the cutting edge of the invention may be obtained even where the outer surface 502b of the cutting edge tip 502 is not a perfect curve. It is to be appreciated that a series of points along the curve can accurately define the curve even where the line between the points may or may not lie on the curve. Further, while the equations described above and the nodal points set forth below define the surface with a great degree of accuracy the outer surface of a cutting edge tip may vary slightly from these perfect curves. An approximation of the curve defined by the equations set forth above may be identified by identifying nodal points that adequately define the outer surface of the edge tip. A cutting edge tip having an outer surface 502b lying within the following x, y nodal points defines an outer surface having the cutting and durability benefits of the invention:

TABLE 1
Line A-A

| X Coordinate in inches | Y Coordinate in inches |
|---|---|
| 0 | 0 |
| 0.004 | 0.0012 |
| 0.008 | 0.0048 |
| 0.012 | 0.0108 |
| 0.016 | 0.0193 |
| 0.020 | 0.030 |
| 0.0229 | 0.040 |

TABLE 2
Line B-B

| X Coordinate in inches | Y Coordinate in inches |
|---|---|
| 0 | 0 |
| 0.003 | 0.0012 |
| 0.006 | 0.0048 |
| 0.009 | 0.0108 |
| 0.012 | 0.0193 |
| 0.015 | 0.030 |
| 0.0173 | 0.040 |

TABLE 3
Line C-C

| X Coordinate in inches | Y Coordinate in inches |
|---|---|
| 0 | 0 |
| 0.002 | 0.0012 |
| 0.004 | 0.0048 |
| 0.006 | 0.0108 |
| 0.008 | 0.0193 |
| 0.010 | 0.030 |
| 0.0117 | 0.040 |

Positive x values in the table correlate to the positive range of the edge tip equations in all three cases. The equivalent negative x values with given y values may be used to correlate the negative range of the edge tip equation in all three cases. Table 1 is a series of seven nodal points that lie on the previously defined curve, y=74x² and may be used as a measurement technique to ensure that the edge tip curvature is accurate. Table 2 is a series of seven nodal points that lie on the previously defined curve, y=136x² and may be used as a measurement technique to ensure that the edge tip curvature is accurate. Table 3 is a series of seven nodal points that lie on the previously defined curve, y=294x² and may be used as a measurement technique to ensure that the edge tip curvature is accurate.

The more nodal points that are used to define the curve of the outer surface of the edge tip, the more accurately the curve is represented. However, because the height dimension A of edge tip 502 is 0.040 inches, it has been found that the curve can be represented with the 7 nodal points to provide the cutting force characteristics and durability of the invention. Further, it has been found that the first 40 thousands of an inch extending from the distal end 502a of the edge tip 502 along the y-axis are most critical in providing the cutting force characteristics and durability of the cutting edge. Thus, a cutting edge that over the first 40 thousands of an inch (from distal end 502a) has a edge tip that comprises an outer surface having the geometry of the curve set forth herein provides desirable cutting force characteristics and durability. After the first 40 thousandths the tip may vary from the curves set forth above. In the example curves set forth in Tables 1 through 3, the distal end 502a is located at nodal point 0,0 such that the curves are described as a perfect tangent to the x-axis. In actual embodiments the distal end 502a may comprise a flat surface that extends along the x-axis a short distance, for example, 4 thousandths of an inch and still be considered to approximate the defined curve.

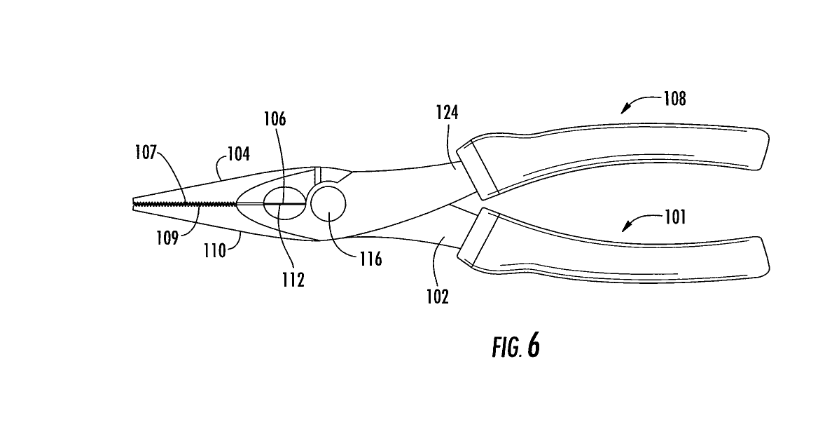

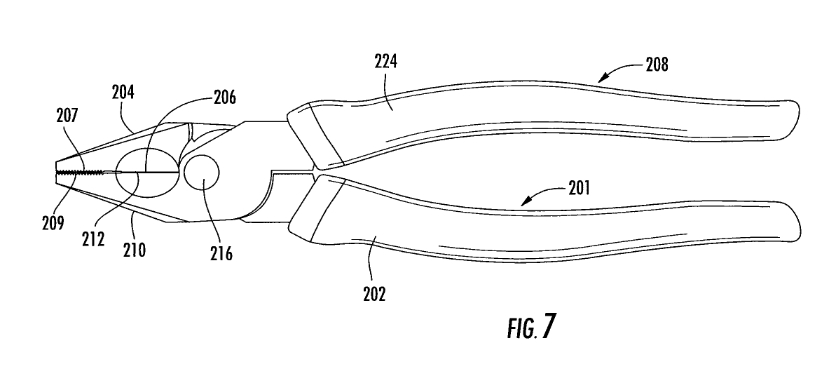

While the cutting edge of the invention has been described with respect to the diagonal pliers of FIG. 1, the cutting edge may be used with a wide variety of cutting tools. FIG. 6 shows an embodiment of a long-nose pliers and FIG. 7 shows an embodiment of a linesman pliers having a two lever construction comprising a first lever assembly 101, 201 comprising a first handle 102, 202 that is fixed to a first jaw 104, 204. The first jaw 104, 204 is formed with a first cutting edge 106, 206. The first jaw 104, 204 also includes an elongated, tapered gripping face 107, 207 extending beyond the cutting edge 106, 206. A second lever assembly 108, 208 comprises a second handle 124, 224 that is fixed to a second jaw 110, 210. The second lever assembly 108, 208 is pivoted to the first lever assembly 101, 201 at pivot 116, 216. The second jaw 110, 210 comprises a second cutting edge 112, 212 and a second elongated, tapered gripping face 109, 209 extending beyond the cutting edge 112, 212. The second cutting edge 112, 212 is disposed opposite to the first cutting edge 106, 206, respectively, such that when jaws 104, 204 and 110, 210 are closed the cutting edges 106, 206 and 112, 212 are in edge-to-edge contact with one another. The gripping faces 107, 207 are also disposed opposite to faces 109, 209, respectively, such that an article may be gripped between the gripping faces. The jaws 204 and 210 and gripping faces 207 and 209 of a typical linesman pliers, shown in FIG. 7, are relatively shorter and blunter than the jaws 104 and 110 and gripping faces 107 and 109 of a typical long-nose pliers, shown in FIG. 6.

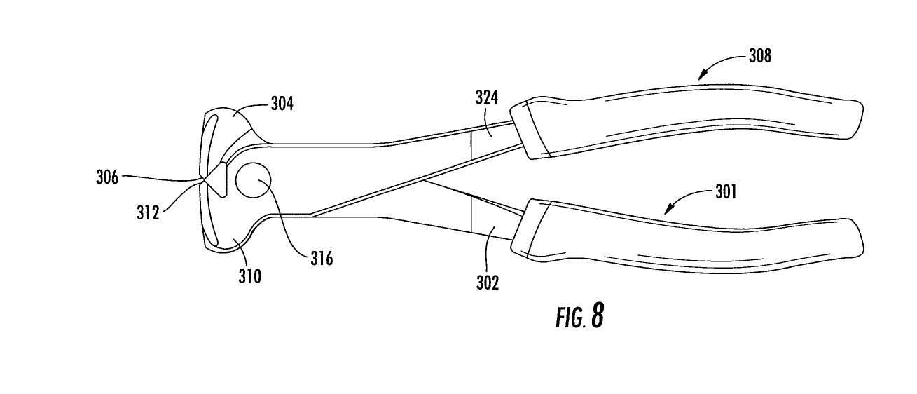

FIG. 8 shows an embodiment of an end cutter having a two lever construction. The end cutter comprises a first lever assembly 301 comprising a first handle 302 that is fixed to a first jaw 304. The first jaw 304 is formed with a first cutting edge 306 that extends essentially parallel to the axis of rotation of the lever assemblies about pivot 316. The cutting edge 306 is oriented perpendicular to the cutting edge in the previously described embodiments. A second lever assembly 308 comprises a second handle 324 that is fixed to a second jaw 310. In one embodiment the handles and jaws may be made integrally with one another and may have a one-piece construction. The second lever assembly 308 is pivoted to the first lever assembly 301 at pivot 316. The second jaw 310 comprises a second cutting edge 312 that is opposed to cutting edge 306. The first jaw 304 can rotate toward and away from the second jaw 310 such that an article may be located between the cutting edges 306 and 312 and cut.

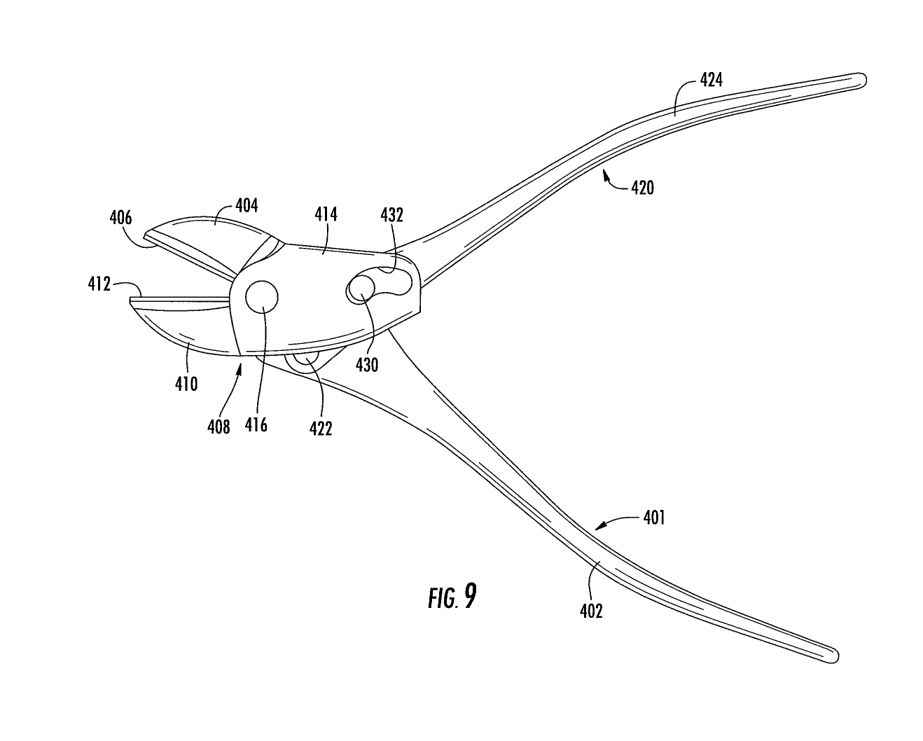

Referring to FIG. 9 an embodiment of a diagonal cutting tool is shown comprising a first lever assembly 401 that comprises a first handle 402 fixed to a first jaw 404 formed with a first cutting edge 406. A second lever assembly 408 comprising a second jaw 410 having a second cutting edge 412 is fixed to and pivoted relative to the first lever assembly 401 at pivot 416. The second cutting edge 412 is disposed opposite to the first cutting edge 406 such that when jaws 404 and 410 are closed the cutting edges 406, 412 are in edge-to-edge contact with one another. The second lever assembly 408 comprises a stub 414 located on the opposite side of pivot 416 from jaw 410.

A third lever assembly 420 is fixed to and pivoted relative to the first lever assembly 401 at a second pivot 422. The third lever assembly 420 is also connected to the second lever assembly 408 by a pin 430 formed on the third lever assembly 420 that engages a slot 432 formed on the stub 414 of the second lever assembly 408. The third lever assembly 420 comprises a handle 424 that extends generally opposite to the first handle 402. A user may press the handles toward one another such that the engagement of pin 430 with slot 432 rotates second lever assembly 408 to close the jaws 404 and 410.

The cutting tools described above are provided by way of example. The cutting edge of the invention may be used on any cutting tool where the cutting edge construction described herein provides the cutting force and durability advantages described herein.

A method of making a cutting tool comprises providing a first cutting edge and a second cutting edge where the first cutting edge and the second cutting edge are movable into engagement with one another (block 1001). One method of manufacturing a cutting edge is to forge the jaws pieces, machine the pieces, assemble the jaws together such as by a rivet, heat treat the jaws, and laser harden the edge. An edge tip is provided along at a least a portion of the first cutting edge (block 1002). The edge tip is shaped to have a curved surface that is within the range defined by a first line defined by the equation y=74x² where x is within the range −0.023 inches≦x≦0.023 inches and a second line defined by the equation y=294x² where x is within the range −0.012 inches≦x≦0.012 inches (block 1003). The edge tip shape can be ground into the desired shape before or after assembly of the pliers. It is also possible to create inserts that have the shaped cutting edges where the inserts are separately attached to the jaws. The inserts may be manufactured using various methods including EDM, machining, grinding, and investment casting. Alternatively, the jaws and cutting edges may be investment cast, machined and assembled. Another alternate method of manufacturing is to investment cast the jaws and use composite construction for the handles. The edge tip may be further shaped to have a curved surface that is defined by a third line defined by the equation y=136x² where x is within the range −0.017 inches≦x≦0.017 inches (block 1004).

While embodiments of the invention are disclosed herein, various changes and modifications can be made without departing from the spirit and scope of the invention as set forth in the claims. One of ordinary skill in the art will recognize that the invention has other applications in other environments. Many embodiments are possible. The following claims are in no way intended to limit the scope of the invention to the specific embodiments described above.

1. A cutting tool comprising:
a first cutting edge and a second cutting edge, said cutting edges being movable into engagement with one another;
said first cutting edge comprising a edge tip extending along at least a portion of said cutting edge, said edge tip having a curved surface that is within the range defined by a first line defined by the equation y=74x² where x is within the range −0.023 inches≦x≦0.023 inches and a second line defined by the equation y=294x² where x is within the range −0.012 inches≦x≦0.012 inches.

2. The cutting tool of claim 1 wherein a plane extends along the first cutting edge and the second cutting edge and said edge tip is symmetrical about the plane.

3. The cutting tool of claim 1 wherein said first cutting edge is formed on a first jaw and said first jaw is operatively connected to a first lever arm and said second cutting edge is formed on the second jaw and said second jaw is operatively connected to a second lever arm.

4. The cutting tool of claim 3 wherein the first lever arm is pivotably connected directly to the second lever arm.

5. The cutting tool of claim 3 wherein the first lever arm is pivotably connected to the first jaw.

6. The cutting tool of claim 3 wherein the first lever arm is formed integrally with the first jaw and the second lever arm is formed integrally with the second jaw.

7. The cutting tool of claim 1 wherein the second cutting edge has a second curved surface that is the same as the curved surface of the first cutting edge.

8. The cutting tool of claim 1 wherein the second cutting edge comprises a second edge tip extending along at least a portion of the second cutting edge, the second edge tip having a curved surface that is within the range defined by a first line defined by the equation y=74x² where x is within the range −0.023 inches≦x≦0.023 inches and a second line defined by the equation y=294x² where x is within the range −0.012 inches≦x≦0.012 inches.

9. The cutting tool of claim 3 wherein the first jaw and second jaw comprise gripping surfaces.

10. The cutting tool of claim 3 wherein the first cutting edge extends for the length of the first jaw and the second cutting edge extends for the length of the second jaw.

11. The cutting tool of claim 1 wherein the curved surface is defined by a third line defined by the equation y=136x² where x is within the range −0.017 inches≦x≦0.017 inches.

12. A cutting tool comprising:
a first cutting edge and a second cutting edge, said cutting edges being movable into engagement with one another;
said first cutting edge comprising a edge tip extending along at least a portion of said cutting edge, said edge tip having an outer surface that is within the range defined by a first line defined by the equation y=74x² where x is within the range −0.023 inches≦x≦0.023 inches and a second line defined by the equation y=294x² where x is within the range −0.012 inches≦x≦0.012 inches, where seven values of y and seven values of x are used to define the curve.

13. The cutting tool of claim 12 wherein the first cutting edge and the second cutting edge make edge-to-edge contact.

14. A cutting tool comprising:
a first cutting edge and a second cutting edge, said cutting edges being movable into engagement with one another;
said first cutting edge comprising a edge tip having a distal end and extending along at least a portion of said cutting edge, said edge tip having an outer surface that is within the range defined by a first line defined by the equation y=74x² where x is within the range −0.023 inches≦x≦0.023 inches and a second line defined by the equation y=294x² where x is within the range −0.012 inches≦x≦0.012 inches, and where y extends between 0 and 0.040 inches from the distal end.

15. The cutting tool of claim 14 wherein said first cutting edge is formed on a first jaw and said first jaw is operatively connected to a first lever arm and said second cutting edge is formed on the second jaw and said second jaw is operatively connected to a second lever arm.

16. The cutting tool of claim 15 wherein the first lever arm is pivotably connected directly to the second lever arm.

17. The cutting tool of claim 14 wherein a cross-sectional area of the edge tip from the distal end to a transverse line that is 0.040 inches from the distal end is approximately 0.001 square inches.

18. A method of making a cutting tool comprising;
providing a first cutting edge and a second cutting edge where the first cutting edge and the second cutting edge are movable into engagement with one another;
providing a edge tip along at a least a portion of the first cutting edge;
shaping the edge tip to have a curved surface that is within the range defined by a first line defined by the equation y=74x² where x is within the range −0.023 inches≦x≦0.023 inches and a second line defined by the equation y=294x² where x is within the range −0.012 inches≦x≦0.012 inches.

19. The cutting tool of claim 18 further comprising shaping the edge tip to have a curved surface that is defined by a third line defined by the equation y=136x² where x is within the range −0.017 inches≦x≦0.017 inches
